(19) United States
(12) Patent Application Publication
(10) Pub. No.: US 2008/0216769 A1
(43) Pub. Date: Sep. 11, 2008

(54) PET LEASH WITH RESILIENT, COILED, NON-TANGLING LANYARD AND COMFORTABLE WRAP AROUND HANDLE

(76) Inventor: Jeanna LaCross, St. Augustine, FL (US)

Correspondence Address: MARK YOUNG, P.A., 12086 FORT CAROLINE ROAD, UNIT 202, JACKSONVILLE, FL, 32225, US

(21) Appl. No.: 11/681,789

(22) Filed: Mar. 5, 2007

(51) Int. Cl. A01K 27/00; A01K 1/08

(52) U.S. Cl. 119/798; 119/776

(57) ABSTRACT

An animal leash includes a resilient elastomeric coil having a distal end and a proximal end, a resilient elastomeric distal lead attached to the distal end of the coil, a resilient elastomeric proximal lead attached to the proximal end of the coil, a distal swivel attached to the distal lead, a proximal swivel attached to the proximal lead, a spring clip coupled to the distal swivel, a cushioned handle and a coupling adjoining the handle to the proximal swivel. The coil and distal and proximal leads are configured to provide two modes of stretching, including a spring mode wherein the coil substantially linearly extends as increasing tensile force is applied, and a strain mode wherein the coil and distal and proximal leads are strained according to a modulus of elasticity. The swivels resist twisting. The handle provides a comfortable structure that can be gripped or worn as a wrist band. Additionally, excess cord may be wrapped around the cushioned handle without causing discomfort to the user. A supplemental handle may be disposed between the distal end of the coil and the proximal end of the clip.

### FIELD OF THE INVENTION

This invention generally relates to animal leashes, and, more particularly, to a leash having a resilient, coiled, non-tangling lanyard and a comfortable wrap-around handle.

### BACKGROUND

A conventional leash or a lead is a line attached to the neck of a pet (often a dog) for restraint or control. Some leashes clip or tie to collars or harnesses, while others go directly around the animal's neck. A properly handled leash restrains animals to prevent them from frightening or biting people or other animals, wandering into traffic and getting lost.

A common type of leash is comprised of nylon webbing, usually 6 to 9 feet, with a looped webbing handle at one end and a clip at the other end. While such leashes provide considerable control over an animal, they do little to relieve the stresses experienced as an animal jerks on the leash. Dogs frequently pull abruptly on a leash with considerable force in an effort to run or play or to chase a vehicle or another animal. The leash transmits the pulling force to the handler's hand and arm, causing considerable discomfort. If the leash is wrapped around the handler's hand, as is common to shorten the length, the force may cause considerable discomfort in the handler's hand. Concomitantly, such leashes become easily twisted because there is no swivel at the interface with the handle. Such twisting makes the leash more difficult to grasp and control.

Such conventional leashes also do little to prevent tangling. When an animal is close to its handler, the leash slackens. The slack often drags the ground and annoyingly tangles around a dog's legs. As discussed above, if the slack is taken up by wrapping the leash around the handler's hand, subsequent jerking force exerted by the animal may cause considerable discomfort in the handler's hand.

Another common type of leash features a long thin rope that retracts into a large plastic handle, allowing a dog to wander 15 or 25 feet away while keeping the leash taut. When locked, such a leash transmits pulling force to the handler's hand and arm, causing considerable discomfort. When unlocked, the leash readily extends up to its maximum length under minimal tensile force, making an animal difficult to control. The handler may retract and lock the leash for closer control, to eliminate excess slack and reduce the tendency to entangle with the animal's front legs. Additionally, this plastic handle contains a complex retracting mechanism that is conducive to jamming, with components susceptible to corrosion and structural failure.

What is needed is a leash that, among other things, resists tangling and twisting, stretches to a determined length to allow a leashed pet to wander within a controllable range, absorbs shock when jerked, and provides a comfortable handle that protects hands. The invention is directed to overcoming one or more of the problems and solving one or more of the needs as set forth above.

### SUMMARY OF THE INVENTION

To solve one or more of the problems set forth above, in an exemplary implementation of the invention, a leash having a resilient, coiled, non-tangling lanyard and a comfortable wrap around handle is provided. In a particular preferred embodiment, the animal leash includes a resilient elastomeric coil having a distal end and a proximal end, a resilient elastomeric distal lead attached to the distal end of the coil, a resilient elastomeric proximal lead attached to the proximal end of the coil, a distal swivel attached to the distal lead, a proximal swivel attached to the proximal lead, a spring clip coupled to the distal swivel, a cushioned handle and a coupling adjoining the handle to the proximal swivel. The coil and distal and proximal leads are configured to provide two modes of stretching, including a spring mode wherein the coil substantially linearly extends as increasing tensile force is applied, and a strain mode wherein the coil and distal and proximal leads are strained according to a modulus of elasticity. The swivels resist twisting. The handle provides a comfortable structure that can be gripped or worn as a wrist band. Additionally, excess cord may be wrapped around the cushioned handle without causing discomfort to the user. Such wrapping takes up slack, while the handle aids in comfort by cushioning a handler's hand, wrist or arm. Thus, a handler may exercise control, such as by resisting or pulling in an animal, without suffering appreciable discomfort to the handler's hand, wrist or arm.

Thus, an exemplary animal leash according to principles of the invention includes a resilient elastomeric coil having a distal end and a proximal end, a handle, a handle coupling adjoining the handle to the proximal end of the coil, a spring clip, and a clip coupling adjoining the spring clip to the distal end of the coil. In one embodiment, the clip coupling comprises a resilient elastomeric distal lead having a proximal end and a distal end and being attached by its proximal end to the distal end of the coil. In another embodiment, the handle coupling comprises a resilient elastomeric proximal lead having a proximal end and a distal end and being attached by the distal end to the proximal end of the coil. In another embodiment the clip coupling comprises a resilient elastomeric distal lead having a proximal end and a distal end and being attached by its proximal end to the distal end of the coil, and a distal swivel attached to the distal end of the distal lead, the clip being attached to the distal swivel. In yet another embodiment the handle coupling comprises a resilient elastomeric proximal lead having a proximal end and a distal end and being attached by the distal end to the proximal end of the coil, and a proximal swivel attached to the proximal end of the proximal lead, the handle being attached to the proximal swivel. In an alternative embodiment, the clip coupling comprises a distal swivel and a resilient elastomeric distal lead having a proximal end and a distal end and being attached by its proximal end to the distal swivel, the distal swivel being attached to the distal end of the coil. In an alternative embodiment, the handle coupling comprises a proximal swivel and a resilient elastomeric proximal lead having a proximal end and a distal end and being attached by the distal end to the proximal swivel, the proximal swivel being attached to the proximal end of the coil.

The handle may be an adjustable cushioned handle. The handle may include a releasable fastener such as a hook and loop fastener configured for releasably fastening the handle.

The coil is configured to provide two modes of stretching including a spring mode wherein the coil substantially linearly extends as increasing tensile force is applied, and a strain mode wherein the coil is strained according to a modulus of elasticity as increasing tensile force is applied. The coil may be comprised of an elastomer having a durometer of 20 to 80 (Shore A).

A supplemental handle may be disposed between the distal end of the coil and the clip. An exemplary supplemental handle includes a hand grip and a hand guard.

The coil may be formulated with various additives. For example, the coil may be formulated with a thermochromic additive in an amount effective to cause the coil to change color when ambient temperature exceeds a determined temperature, and/or a photochromic additive in an amount effective to cause the coil to change color when the coil is exposed to ambient lighting, and/or a phosphorescent additive in an amount effective to cause the coil to absorb light energy and continue to release that energy as visible light after the light source is unavailable.

### BRIEF DESCRIPTION OF THE DRAWINGS

The foregoing and other aspects, objects, features and advantages of the invention will become better understood with reference to the following description, appended claims, and accompanying drawings, where:

FIG. 1 conceptually shows a plan view of an exemplary leash having a resilient, coiled, non-tangling lanyard and a comfortable wrap-around handle in a substantially unstretched configuration according to principles of the invention; and

FIG. 2 conceptually shows a plan view of an exemplary leash having a resilient, coiled, non-tangling lanyard and a comfortable wrap-around handle in a substantially stretched configuration according to principles of the invention; and

FIG. 3 is a table of tensile test data for a leash according to principles of the invention featuring a coiled polyurethane cord, with a diameter of 7 mm, 15 coils and length of coiled portion of about 160 mm, conducted at room temperature 23° C.; and

FIG. 4 is a chart of tensile test data for a leash according to principles of the invention featuring a coiled polyurethane cord, with a diameter of 7 mm, 15 coils and length of coiled portion of about 160 mm, conducted at room temperature 23° C.; and

FIG. 5 conceptually shows a plan view of an exemplary leash having a resilient, coiled, non-tangling lanyard, and a comfortable wrap-around handle, and a supplemental handle configured for enhanced control of an animal.

Those skilled in the art will appreciate that the figures are not intended to be drawn to any particular scale; nor are the figures intended to illustrate every embodiment of the invention. The invention is not limited to the exemplary embodiments depicted in the figures or the types of components, shapes, relative sizes, ornamental aspects or proportions shown in the figures.

### DETAILED DESCRIPTION

An exemplary animal leash according to principles of the invention includes a resilient elastomeric coil having a distal end and a proximal end, a handle, a handle coupling adjoining the handle to the proximal end of the coil, a spring clip, and a clip coupling adjoining the spring clip to the distal end of the coil. The couplings may include any means for adjoining a handle or clip to the coil. Such couplings may, for example, include separate components such as leads or other mechanical linkages, bonds such as chemical or thermal bonds, integral joints such as a handle integrally formed with the coil or a clip integrally formed with the coil. The invention is not limited to any particular means or method of coupling.

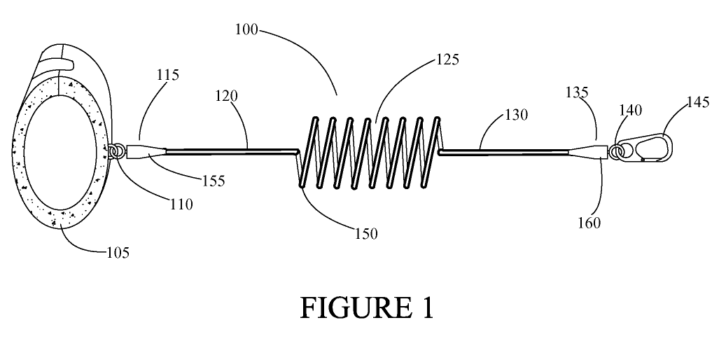

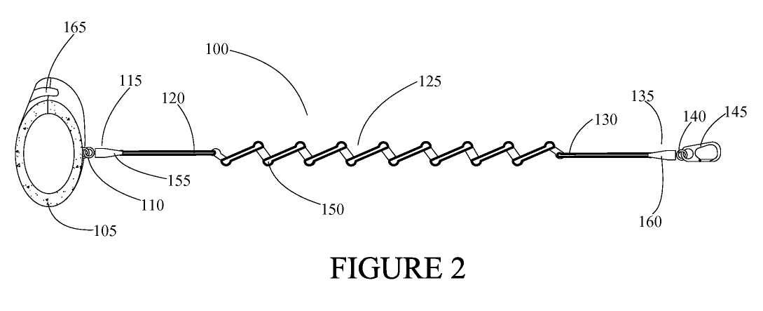

Referring now to the Figures, in which like parts are indicated with the same reference numerals, various views of an exemplary leash 100 having a resilient, coiled, non-tangling lanyard and a comfortable wrap-around handle in various states of extension according to principles of the invention are shown in FIGS. 1 and 2. The leash 100 is adapted for controllably coupling an animal to a handler, so that the handler may control the animal and yet provide flexibility for the animal to wander within range of the leash. As shown in FIG. 2, the leash 100 has a coil 125. The coil 125 has a plurality of loops 150 that are adjacent to each other. The loops 150 are not limited to any particular shape. Thus, for example, the loops 150 may feature circular or elliptical cross-sections.

The coil 125 is preferably constructed from a resilient, durable elastomer, such as (but not limited to) a urethane having a durometer of 40 to 60 (Shore A), which exhibits good flexibility, strength and resiliency for use in an animal leash. When the animal wanders from the handler, it is desirable to be able to quickly pull the animal back. A 20 to 80 and more preferably 40 to 60 (Shore A) durometer material has been found to be resilient and strong enough to quickly pull the animal back, and yet flexible enough to not shock the handler as the two become separated.

The loops 150 form a cylindrical shaped coil that has a longitudinal axis. Additionally, the loops 150 are constructed to expand and contract, so that there is always tension in the coil 125. This constant tension prevents any excess coil 125 from becoming entangled.

The coil and leash may be any size suitable for handling an animal. By way of example and not limitation, in an exemplary embodiment the leads and coil cord (i.e., lanyard) are approximately 3 mm to 10 mm or ⅛ to ⅜ inches in diameter. Each loop of the coil may be approximately 1 inch to 4 inches in diameter, or 25 to 100 mm, for example.

As shown in FIGS. 1 and 2, the leash 100 preferably has proximal 120 and distal 130 leads extending to and from the coil 125. As used herein proximal refers to near the handle 105, and distal refers to near the animal clip 145. The leads 120, 130 are preferably comprised of the same material as the coil 125 and formed as an integral part thereof. The combined un-extended length of the coil 125 and leads 120, 130 is preferably approximately 4 to 9 feet, although other lengths may be utilized and are intended to come within the scope of the invention.

Optionally, attached to each lead 120, 130 are proximal 115 and distal 135 swivel joints. Each swivel joint 115, 135 has a first body portion 155, 160 that attaches to the respective lead 120, 130. Extending from the first body portions are couplings 110, 140 adapted to rotate 360 degrees relative to the first body portions 155, 160 and the coil 125. The distal swivel joint 135 is coupled to a clip 145 such as a spring clip suitable for releasable attachment to a collar. The proximal swivel joint 115 is permanently or releasably coupled to a handle 105. Those skilled in the art will appreciate that a leash according to principles of the invention is not limited to having both a proximal 115 and distal 135 swivel joint. Rather, fewer or more swivel joints, of the same or different construction, may be utilized within the scope of the invention. However, preferably at least one swivel joint is provided to prevent twisting and binding.

The invention is not limited to any particular clip 145. Any structural ring with a spring actuated or threaded locking or non-locking gate may be utilized to quickly and reversibly connect the leash to an animal collar. The clip may be oval, D-shaped, rectangular, offset-D, pear/HMS (Halbmastwurfsicherung)-shaped, or any other shape or configuration suitable for releasably coupling to an animal collar.

The invention is also not limited to the arrangement of swivels, couplings and clips as described above. Swivels, which are optional, may be provided distal or proximal to couplings. Clips may be attached to couplings and/or to swivels. The particular arrangement and configuration is not important, so long as the leash includes a handle at its proximal end, a clip for connecting to a collar at the distal end of the leash, and a resilient elastomeric coil disposed between the handle and clip.

The invention includes a handle for holding the leash. Such handles may be rigid or flexible, formed of any material that provides adequate structural integrity, and have any configuration suitable for grasping. While the invention is not limited to any particular type of handle, in a preferred embodiment, a cushioned handle 105 is provided. The exemplary handle 105 may be comprised of a strong, durable, heavily cushioned fabric or webbing, dimensioned for encircling a fist, wrist and/or arm and configured for gripping. Cushioning may be provided by a soft flexible material such as neoprene, the DuPont Performance Elastomers trade name for synthetic rubber based on polychloroprene (polymer form of chloroprene). The voids, springy consistency, light weight and chemical inertness of neoprene make it an ideal candidate for cushioning. In a particular preferred embodiment, the handle 105 is configured for gripping and wearing around a wrist. The handle has securement means whereby the ends may be adjustably removedly secured together for various sized configurations. In one configuration, the handle may be gripped by a user. In another configuration, the handle may be attached to a user's wrist or arm, to facilitate hands free use, such as during jogging, running or other form of exercise.

A releasable fastener, such as hook and loop straps 165 (e.g., Velcro® strap) or a buckle may be provided to open, close and adjust the size of the handle 105. A hook and loop fastener may include two layers: a “hook” side, which is a piece of fabric covered with tiny plastic hooks, and a “loop” side, which is covered with smaller and “hairier” plastic loops. Variations to this configuration may include hooks and loops on both layers, for example. When the layers are pressed together, the hooks catch in the loops and hold the pieces together. The strength of the hook and loop bond depends on how well the hooks are embedded in the loops and the nature of the force pulling it apart. In an exemplary embodiment, the bond is strong enough to withstand any force exerted by an animal, which is spread evenly across all hooks. However, because the layers are flexible, they can still be easily pulled apart with a peeling action which applies the force to relatively few hooks at a time.

In use, excess portions of the lead 120 may be wrapped around the handle 105. Because the handle 105 is cushioned, tugging by an animal will not cause the wrapped portion of the lead to strangle the handler's wrist or hand and cause great discomfort.

An important aspect of a leash according to principles of the invention is that it provides two modes of extension—a spring mode and strain mode. First, in the spring mode of extension, the coil acts as a tension spring becoming longer under load. The loops are normally touching in the unloaded position. When a tensile load is applied, the coil roughly obeys Hooke's law, whereby elongation is linearly proportional to the applied tensile force. The ratio of the force to the elongation is referred to as the spring constant or force constant of the spring. Advantageously, as discussed below, relatively little force is required to elongate the coil in spring mode. When the tensile force is relieved, the coil returns to its unloaded position with the loops touching. When the coil is extended in spring mode, a tensile force proportional to the extension is exerted. Advantageously, the resistance exerted by the coil in spring mode improves an animal's walking behavior. The slight resistance urges a dog to walk a straighter line.

As the coil approaches full extension, the strain mode of extension predominates. During the strain mode, the exerted forces have substantially extended the coil and begin to strain (i.e., stretch) the leads 120, 130, as well as the elastomeric cord comprising the extended loops 150 of the coil 125. In this mode, the Young's modulus (E) or elastic modulus, which is the ratio of tensile stress to tensile strain, describes the tensile elasticity of the leash, or the tendency of the leash to deform along its longitudinal axis when a tensile force is applied along that axis. In the strain mode of extension, forces that are substantially greater than the forces used to initially extend the coil are required to strain the leads and cord comprising the extended loops.

Thus, when an animal exerts a relatively small force, the coil easily extends in the spring mode, allowing the animal to wander within a controlled range. The range of extension is determined by the size of the coil, i.e., the diameter and number of loops. In an exemplary embodiment, the extended coil may be from approximately 1 to 7 feet in length. When the tensile force is relieved, the coil returns to its un-extended state. When a substantial force is applied, the coil extends, and the leads 120, 130 and elastomeric cord comprising the extended loops 150 of the coil 125 are strained (i.e., stretched). Due to the material properties, including the elastic modulus, the ratio of tensile stress to stretch in the strain mode is substantially greater than the ratio of tensile stress to coil elongation in the spring mode. In other words, the spring mode allows considerable extension with minimal force while the strain mode allows limited additional extension with substantial additional force. The limited additional extension is useful for absorbing the shock from a tugging animal while enabling the handler to maintain control.

Illustratively, tensile tests were performed on a leash with a coiled polyurethane cord, having a diameter of 7 mm, 15 coils and length of coiled portion of about 160 mm at room temperature 23° C. The coiled cord was securely fastened in one end to a table. A force transducer was attached to the other end. The coiled cord was extended in 100 mm increments and the force was recorded. The cord was first extended to 1000 mm which completely straightened out the coil. The uncoiled cord was then stretched an additional 200 mm to record forces beyond the fully uncoiled (i.e., spring) mode. These measurements were made to illustrate the strain mode.

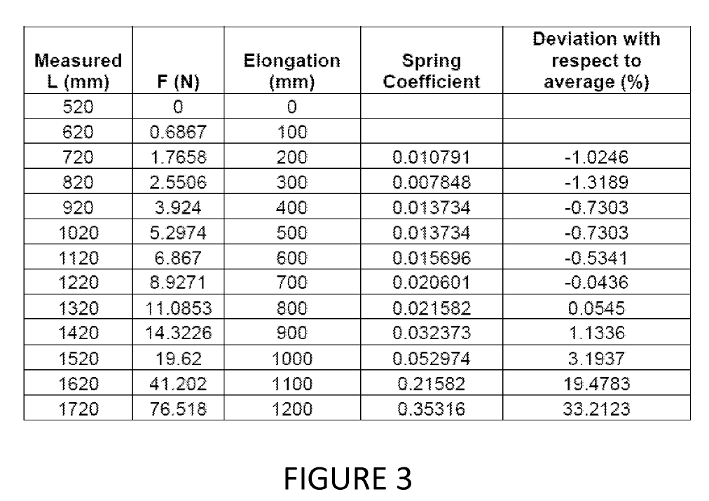

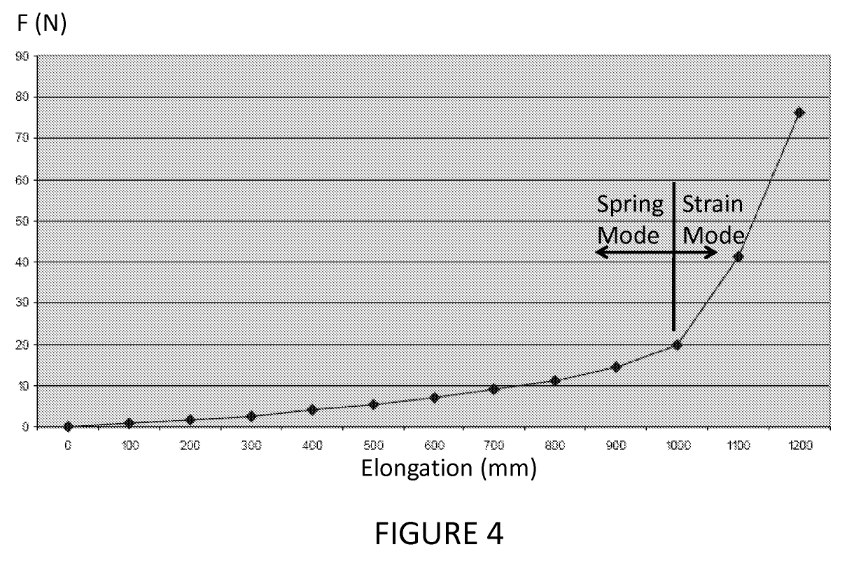

The test data is shown in the table in FIG. 3 and in the graph in FIG. 4. For the exemplary coil, the average spring coefficient, which is roughly equal to the ratio of force to coil elongation, excluding data over 1000 mm elongation, is 0.021 N/mm. As illustrated in the graph of FIG. 4, the first mode of the stretching (i.e., the spring mode) is substantially linear, with a slight deviation perhaps due to measurement inaccuracies and coil properties. The spring portion of the exemplary coil can be elongated up to 1000 mm (25.4 inches), i.e., from 160 mm to 1160 mm, without substantially straining the core material. As the coil becomes fully extended, a transition to strain mode occurs. In the strain mode, the coil is fully extended and the material's modulus of elasticity defines the ratio of stress to strain.

The ultimate tensile strength of the leash 100 is substantially greater than the forces that can be exerted by the animal. Thus, the leash should maintain structural integrity during normal use. The exemplary coil described above exhibits an ultimate tensile strength of approximately 5,000 psi, or 300 pounds of force applied to a 7 mm diameter cord. The ultimate tensile force may be increased by increasing the diameter of the material. The ultimate tensile strength may be increased by using a stronger resilient material and/or by introducing structural reinforcement (e.g., reinforcing fibers) to the material.

A coil 125 and leads 120, 130 according to the invention are not limited to any particular material, such as the polyurethane described above. Instead, any elastomer that is now known or hereafter developed and that provides adequate resiliency, durability, and strength may be utilized within the spirit and the scope of the invention. Nonlimiting examples include formulations of natural rubber, polyisoprene, butyl rubber (i.e., copolymer of isobutylene and isoprene), halogenated butyl rubbers (i.e., chloro butyl rubber and bromo butyl rubber), polybutadiene, styrene-butadiene rubber (i.e., copolymer of polystyrene and polybutadiene), nitrile rubber (copolymer of polybutadiene and acrylonitrile), hydrated nitrile rubbers, chloroprene rubber, polychloroprene, neoprene, EPM (ethylene propylene rubber), EPDM rubber (ethylene propylene diene rubber, epichlorohydrin rubber, polyacrylic rubber, silicone rubber, fluorosilicone rubber, fluoroelastomers such as Viton®, Tecnoflon®, Fluorel® and Dai-El®, perfluoroelastomers such as Kalrez®, tetrafluoro ethylene/propylene rubbers, chlorosulfonated polyethylene, ethylene-vinyl acetate, thermoplastic elastomers (tpe), for example Hytrel®, thermoplastic vulcanizates, for example Santoprene®, polyurethane rubber, resilin, elastin and polysulfide rubber. The coil may further include additives to provide desired properties such as desired colors, structural characteristics, glow-in-the dark properties and thermal reactivity (e.g., color changes according to heat).

By way of example and not limitation, the coil and/or leads may optionally be formulated to change color when it reaches a predetermined or higher temperature. This can be accomplished by mixing a thermochromic additive to the base material in an amount that is sufficient to achieve a desired color changing range. As an example, a mixture of approximately 5% to 30% (pbw) of Matsui International Co., Inc.'s Chromicolor® concentrate may be introduced to the base material, to provide a plastic structure that visibly changes color at a determined elevated temperature, such as approximately 95 degrees Fahrenheit or higher. Such color changing may indicate unsafe temperatures for strenuous activity, especially for elderly or infirm animals.

Alternatively, a photochromic additive may be added to the coil material in an amount that is effective to achieve a desired color change when the coil is exposed to certain lighting conditions. As an example, a mixture of approximately 5% to 35% (pbw) of Matsui International Co., Inc.'s Photopia® additive may be introduced to the base material, to provide a plastic structure that visibly changes color in the presence of sunlight or ultraviolet light.

As another alternative, phosphorescent polymer additives, such as aluminate based phosphors, may be added to provide glow in the dark capability, i.e., absorb light energy and continue to release that energy as visible light after the energy source is removed. Advantageously, such an embodiment provides a coil that is visible in darkened conditions, making the leash easy to spot even at nighttime.

Advantageously, a leash according to principles of the invention offers many advantages over conventional leashes. The distal and/or proximal swivels resist twisting. The coil's tendency to return to its natural un-extended state when it is not stressed virtually eliminates slack that would otherwise drag the ground and annoyingly tangle around a dog's legs. Additionally, this recoiling tendency renders unnecessary the common practice of uncomfortably wrapping slack around a user's hand to avoid dragging and tangling. Concomitantly, the handle provides a comfortable structure that can be gripped or worn as a wrist band. Furthermore, excess cord may be wrapped around the cushioned handle without causing discomfort to the user. Moreover, the leash provides multiple modes of stretching. One mode (i.e., the spring mode) allows a leashed pet to wander within a controllable range. Another mode (i.e., the strain mode) absorbs shock when the extended (i.e., uncoiled) leash is jerked.

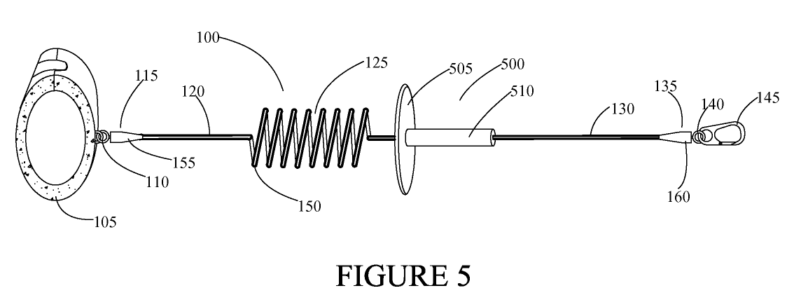

Referring now to FIG. 5, a plan view of another exemplary leash is shown. The leash 100 features a resilient, coiled, non-tangling lanyard, and a comfortable wrap-around handle 105, and a supplemental handle 500 configured for enhanced control of an animal. The exemplary supplemental handle 500 is disposed between the distal end of the coil 125 and the proximal end of the clip 145. The exemplary supplemental handle 500 includes a hand grip 510 and a hand guard 505. The hand guard 505 is a shield configured to prevent a user's hand from sliding off the hand grip 510 when an animal exerts a pulling force. The hand grip 510 may be cylindrical in shape or feature any ergonomic design suitable for comfortable gripping. When firmly grasped by a user, the supplemental handle 500 allows the user to substantially control an animal without allowing any spring mode extension. In this mode of use, only strain mode extension is allowed and only for the elastic material, if any, between the supplemental handle 500 and the clip 145. Illustratively, when vehicles, passersby and/or children approach a dog being walked with a leash as in FIG. 5, then, out of an abundance of caution, the handler may decide to grasp the supplemental handle 500 to maintain maximum control over the dog.

The invention is not limited to a supplemental handle as shown in FIG. 5. A supplemental handle is optional. In embodiments having a supplemental handle, any handle suitable for gripping and controlling the distal end of a leash may be utilized. The handle may have or omit a hand guard. Preferably, the handle is sufficiently strong to withstand forces exerted by an animal and to otherwise transmit the force. The handle should also be sufficiently long to permit reliable gripping by a hand or hands. Additionally, the handle should have a sufficiently small circumference to permit a hand or hands to surround it far enough to reliability grip it. Optionally, a sheath or coating may cover the handle to enhance friction against the hand, thereby reducing the gripping force needed to achieve a reliable grip. A sheath or coating may also be provided on the supplemental handle to cushion a hand.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. An animal leash comprising a resilient elastomeric coil having a distal end and a proximal end, a handle, a handle coupling adjoining the handle to the proximal end of the coil, a spring clip, a clip coupling adjoining the spring clip to the distal end of the coil.

2. An animal leash according to claim 1, wherein the clip coupling comprises a resilient elastomeric distal lead having a proximal end and a distal end and being attached by its proximal end to the distal end of the coil.

3. An animal leash according to claim 1, wherein the handle coupling comprises a resilient elastomeric proximal lead having a proximal end and a distal end and being attached by the distal end to the proximal end of the coil.

4. An animal leash according to claim 1, wherein the clip coupling comprises a resilient elastomeric distal lead having a proximal end and a distal end and being attached by its proximal end to the distal end of the coil, and a distal swivel attached to the distal end of the distal lead, said clip being attached to the distal swivel.

5. An animal leash according to claim 1, wherein the handle coupling comprises a resilient elastomeric proximal lead having a proximal end and a distal end and being attached by the distal end to the proximal end of the coil, and a proximal swivel attached to the proximal end of the proximal lead, said handle being attached to the proximal swivel.

6. An animal leash according to claim 1, wherein the clip coupling comprises a distal swivel and a resilient elastomeric distal lead having a proximal end and a distal end and being attached by its proximal end to the distal swivel, said distal swivel being attached to the distal end of the coil.

7. An animal leash according to claim 1, wherein the handle coupling comprises a proximal swivel and a resilient elastomeric proximal lead having a proximal end and a distal end and being attached by the distal end to the proximal swivel, said proximal swivel being attached to the proximal end of the coil.

8. An animal leash according to claim 1, wherein the handle comprises an adjustable cushioned handle.

9. An animal leash according to claim 1, wherein the handle comprises an adjustable cushioned handle and a releasable fastener configured for releasably fastening the handle.

10. An animal leash according to claim 1, wherein the handle comprises an adjustable cushioned handle and a hook and loop fastener configured for releasably fastening the handle.

11. An animal leash according to claim 1, wherein the coil is configured to provide two modes of stretching including a spring mode wherein the coil substantially linearly extends as increasing tensile force is applied, and a strain mode wherein the coil is strained according to a modulus of elasticity as increasing tensile force is applied.

12. An animal leash according to claim 1, wherein the coil is comprised of an elastomer having a durometer of 20 to 80 (Shore A).

13. An animal leash according to claim 1, wherein the clip coupling comprises a supplemental handle disposed between the distal end of the coil and the clip.

14. An animal leash according to claim 1, wherein the clip coupling comprises a supplemental handle disposed between the distal end of the coil and the clip, said supplemental handle including a hand grip and a hand guard.

15. An animal leash according to claim 1, wherein the coil is formulated with a thermochromic additive in an amount effective to cause the coil to change color when ambient temperature exceeds a determined temperature.

16. An animal leash according to claim 1, wherein the coil is formulated with a photochromic additive in an amount effective to cause the coil to change color when the coil is exposed to ambient lighting.

17. An animal leash according to claim 1, wherein the coil is formulated with a phosphorescent additive in an effective amount to glow in the dark.

18. An animal leash comprising a resilient elastomeric coil having a distal end and a proximal end, a handle, a handle coupling adjoining the handle to the proximal end of the coil, a spring clip, a clip coupling adjoining the spring clip to the distal end of the coil, wherein the clip coupling comprises a resilient elastomeric distal lead having a proximal end and a distal end and being attached by its proximal end to the distal end of the coil, and a distal swivel attached to the distal end of the distal lead, said clip being attached to the distal swivel, and the handle coupling comprises a resilient elastomeric proximal lead having a proximal end and a distal end and being attached by the distal end to the proximal end of the coil, and a proximal swivel attached to the proximal end of the proximal lead, said handle being attached to the proximal swivel.

19. An animal leash according to claim 1, wherein the handle comprises an adjustable cushioned handle and a releasable fastener configured for releasably fastening the handle, and the coil is configured to provide two modes of stretching including a spring mode wherein the coil substantially linearly extends as increasing tensile force is applied, and a strain mode wherein the coil is strained according to a modulus of elasticity as increasing tensile force is applied.

20. An animal leash according to claim 19, wherein the clip coupling comprises a supplemental handle disposed between the distal end of the coil and the clip.
